(19) United States
(12) Patent Application Publication
(10) Pub. No.: US 2016/0283962 A1
(43) Pub. Date: Sep. 29, 2016

(54) SYSTEMS AND METHODS OF USING BLACK BOX DATA TO PROVIDE INCENTIVES FOR VEHICLE PURCHASES

(71) Applicant: Elwha LLC, Bellevue, WA (US)

(72) Inventors: Alistair K. Chan, Bainbridge Island, WA (US); Roderick A. Hyde, Redmond, WA (US); Jordin T. Kare, San Jose, CA (US); Stephen L. Malaska, Redmond, WA (US)

(73) Assignee: Elwha LLC, Bellevue, WA (US)

(21) Appl. No.: 14/671,540

(22) Filed: Mar. 27, 2015

(51) Int. Cl. G06Q 30/02; G06Q 20/10; G06Q 40/08; G07C 5/02; G07C 5/08

(52) U.S. Cl. CPC G06Q 30/0222; G07C 5/02; G07C 5/085; G06Q 40/08; G06Q 20/102

(57) ABSTRACT

A method for incentivizing vehicle purchases includes receiving, by a processing circuit, an indication of a vehicle transaction; receiving, by the processing circuit, an indication of a type of operational data to be provided to the processing circuit as part of the vehicle transaction; receiving, by the processing circuit, an indication of a frequency of transmission of the type of operational data; and providing, by the processing circuit, an incentive for the vehicle transaction based on the type of operational data to be received and the frequency of transmission of the operational data to be provided by a black box.

### BACKGROUND

For many years, airplanes have been manufactured to include flight recorders (commonly known as the “black box” for the airplane). The flight recorders are designed to receive, track, and store data pertaining to operation of the airplane (e.g., trip duration, starting and end points for a trip, weather conditions at various points during the trip, average altitude, communication between the pilots and between the pilot(s) and a control center, data pertaining to the functionality of various components on an airplane, and the like). The collected data is often used to examine the cause of an accident or incident. Not only is the black box data useful in determining the cause of an accident, but many companies have started using the data for various research and development purposes. Accordingly, the use and prevalence of black boxes has increased and transcended into other industries, such as the automotive industry. Many vehicles include a “black box” designed to track various operating characteristics of the vehicle.

### SUMMARY

One embodiment relates to a system for incentivizing vehicle purchases. The system includes a processing circuit communicably coupled to a memory device for storing operational data regarding operation of a vehicle. The processing circuit is structured to receive customer data regarding a customer for the vehicle; receive purchase data regarding a purchase of the vehicle; and provide an incentive for purchase of the vehicle based on the customer data, purchase data, and an agreement by the customer to provide the operational data. According to one embodiment, the incentive includes a financial incentive provided at an upfront time in the transaction (e.g., at or near completion of the vehicle transaction). Accordingly, the recipient of the financial incentive receives an immediate financial impact, which may cause the recipient (e.g., customer) to indeed purchase the vehicle.

Another embodiment relates to a system. The system includes a black box for acquiring operational data regarding operation of a vehicle and a processing circuit communicably coupled to a memory device for receiving the operational data. The processing circuit is structured to: receive an indication of a vehicle transaction; receive, as part of the vehicle transaction, an indication of a type of operational data provided to the memory; receive, as part of the vehicle transaction, an indication of a frequency of transmission of the operational data to the memory device; and provide an incentive for a purchase of the vehicle in the vehicle transaction based on the type of operational data provided and the frequency of transmission of the operational data.

Still another embodiment relates to a system for incentivizing vehicle purchases. The system includes a processing circuit structured to: receive, as part of a vehicle transaction, an indication of a type of operational data to be received; receive, as part of the vehicle transaction, an indication of a frequency of transmission of the operational data to be received; receive, as part of the vehicle of transaction, customer data regarding a customer of the vehicle; and provide an incentive for a purchase of the vehicle in the vehicle transaction based on the type of operational data provided, the frequency of transmission of the type of operational data, and the customer data.

Yet another embodiment relates to a system for incentivizing vehicle purchases. The system includes a vehicle having a black box, the black box structured to: receive purchase data regarding a purchase of the vehicle, the purchase data including an incentive that was provided in exchange for an agreement to provide operational data regarding operation of the vehicle; acquire the operational data based on the purchase data; and selectively transmit the acquired operational data.

Another embodiment relates to a method for incentivizing vehicle purchases. The method includes receiving, by a processing circuit, customer data regarding a customer for a vehicle; receiving, by the processing circuit, purchase data regarding a purchase of the vehicle; and providing, by the processing circuit, an incentive for the purchase of the vehicle based on the customer data, the purchase data, and an agreement by the customer to provide operational data regarding operation of the vehicle.

Still another embodiment relates to a method for incentivizing vehicle purchases. The method includes receiving, by a processing circuit, an indication of a vehicle transaction; receiving, by the processing circuit, an indication of a type of operational data to be provided to the processing circuit as part of the vehicle transaction; receiving, by the processing circuit, an indication of a frequency of transmission of the type of operational data to; and providing, by the processing circuit, an incentive for the vehicle transaction based on the type of operational data to be received and the frequency of transmission of the operational data to be provided by a black box.

Another embodiment relates to a method of incentivizing vehicle purchases. The method includes providing, by a processing circuit, an incentive for a purchase of a vehicle based on receipt of operational data regarding operation of the vehicle; receiving, by the processing circuit, the operational data upon completion of the vehicle transaction; and compartmentalizing, by the processing circuit, the received operational data based on at least one of a type of operational data received and an incentive provided. According to one embodiment, the method further includes providing, by the processing circuit, the received operational data to a party of interest. The party of interest may include an insurance company for vehicle and/or a party that purchases the received operational data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram of a system for incentivizing vehicle purchases, according to one embodiment.

FIG. 2 is a schematic diagram of a vehicle with a black box, according to one embodiment.

FIG. 3 is a schematic diagram of a black box for a vehicle communicably coupled to a processing circuit, according to one embodiment.

FIG. 4 is a flowchart of a method of incentivizing vehicle purchases, according to one embodiment.

FIG. 5 is a flowchart of a method of incentivizing vehicle purchases, according to another embodiment.

FIG. 6 is a flowchart of a method of incentivizing vehicle purchases, according to still another embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the Figures generally, various embodiments disclosed herein relate to systems and methods of incentivizing vehicle purchases in exchange for black box data relating to operation of the purchased vehicle. As described herein, a “black box” (e.g., an event data recorder data, etc.) may be included with a vehicle or sold separately and installed in the vehicle as part of the vehicle transaction. Once installed, the black box is communicably coupled to one or more vehicle systems (e.g., on-board detection system, powertrain system, etc.) to acquire data (e.g., operational data, black box data, etc.) regarding operation of those systems. Many companies (e.g., insurance, etc.) have an interest in obtaining the black box data to monitor how vehicles and components of vehicles operate. Additionally, the black box data may help in determining a cause of an accident to determine placement of fault (e.g., whether an insurance company should satisfy a claim, seek subrogation, etc.). According to various embodiments of the present disclosure, a processing circuit is communicably coupled to one or more vehicle dealerships. The processing circuit is structured to provide an incentive to potential customers for them to purchase a vehicle in exchange for providing black box data. According to one embodiment, the incentive is a financial incentive, such as a cash rebate, a loan, and/or a lower monthly payment. The incentive may be based on at least one of the type of vehicle purchased, a characteristic of the black box data provided (e.g., a frequency of how often the data is provided, a type of black box data that is provided, etc.), a type of purchase transaction (e.g., full purchase, a lease agreement, etc.), and one or more conditions of the purchase agreement (e.g., terms of purchase such as a percentage of money down relative to the total cost of the vehicle). As a result, the incentive may increase the likelihood that potential customers actually purchase the vehicle. Moreover, while the potential customers gain the benefit of the incentive, the companies that provide the incentive may gain the benefit of the operational data.

According to one embodiment, an association of insurance companies pool/combine resources to provide the incentive to customers. While the incentive helps the vehicle dealership(s) sell vehicles, the insurance companies may not see an immediate financial benefit due to there being no guarantee that the customer buys insurance from their company. According to one embodiment, the operational data is provided to all insurance companies in the association of insurance companies. According to another embodiment, the operational data is only provided to the insurance company that the customer uses or has selected for insuring the purchased vehicle rather than each company in the association. Accordingly, the selected insurance company obtains the benefit of insuring the purchased vehicle.

In still other embodiments, the operational data may be collected, compartmentalized, and sold to or by third parties (e.g., a data collection agency, etc.). For example, while insurance companies may not want to provide a financial incentive for the purchase of the vehicle because there is no guarantee that the customer selects their company for insurance, the insurance companies may have a desire to obtain the operational data after various events (e.g., an accident, etc.). For example, the operational data may include potentially exculpating data for the insurance company. In this regard, the black box data may be provided in an on-demand fashion via a data collection agency to the interested company or individual. These and other features of the present disclosure are described more fully herein.

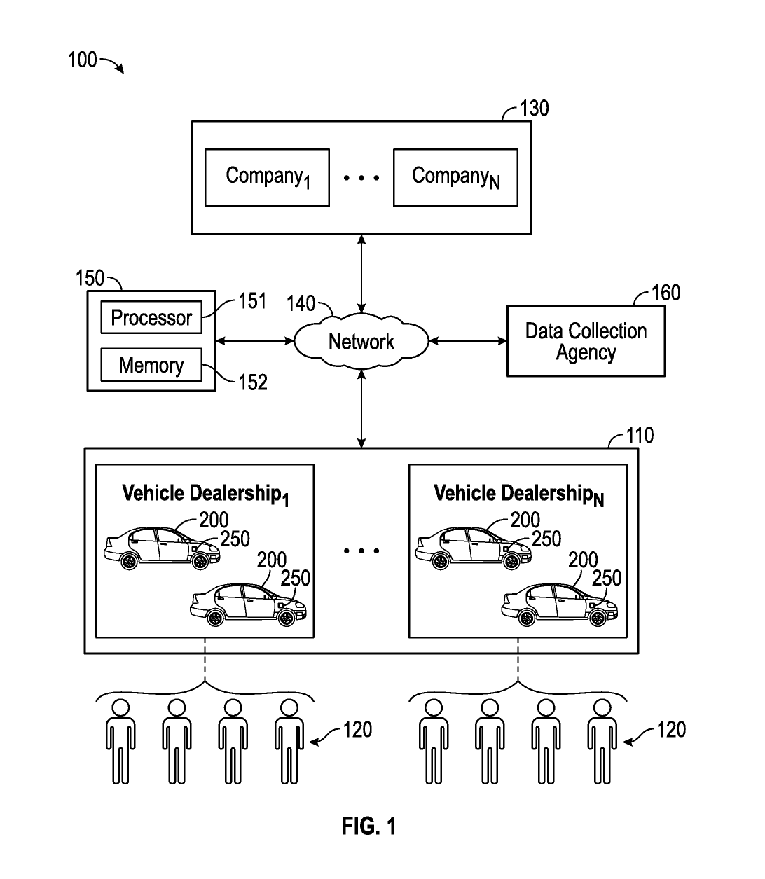

Referring now to FIG. 1, system 100 for incentivizing vehicle purchases is shown according to one embodiment. As shown, system 100 includes vehicle dealerships 110 that interact with customers 120. Vehicle dealerships 110 communicate with companies 130, processing circuit 150, and data collection agency 160 over network 140. As described herein, processing circuit 150 is structured provide an incentive to dealerships 110 to incentivize vehicle purchases. In another embodiment, processing circuit 150 is structured to provide an incentive directly to a customer for use in either a set of dealerships, or in whichever dealership the customer selects.

Vehicle dealerships 110 may include any type of dealership that sells, leases, and otherwise provides vehicles to customers 120. While vehicle dealerships 110 are shown as an association of dealerships, in some embodiments, only one dealership is included in system 100. According to the present disclosure, vehicle dealerships 110 are structured to provide (e.g., sell, etc.) either vehicle 200 or black box 250 to customer 120.

Companies 130 may include any type of company, individual, or business interested in receiving operational data regarding operation of one or more vehicles (e.g., vehicles sold by dealership 110 to customer 120). In one embodiment, companies 130 are structured as an aggregation or association of insurance companies (e.g., a homogenous mixture of company types). In other embodiments, companies 130 include one or more insurance companies and one or more of any other type of company that is interested in operational data (e.g., a heterogonous mixture of company types). In still other embodiments, only one company may be a part of system 100. For example, a specific agreement may be in place between a particular vehicle dealership 110, such that, via processing circuit 150, company 130 only provides incentives to that dealership 110. In other embodiments, the full or a portion of companies 130 may provide incentives, via processing circuit 150, to one or more vehicle dealerships 110. All such variations are intended to fall within the spirit and scope of the present disclosure.

System 100 includes data collection agency 160. Data collection agency 160 may be structured as any third party interested in collecting and selling operational data relating to operation of one or more vehicles. In one embodiment, data collection agency 160 includes processing circuit 150. In another embodiment, data collection agency 160 is excluded from system 100. Data collection agency 160 may serve as an intermediary between vehicle dealerships 110 and companies 130. In this example, data collection agency 160 provides the incentive to customer 120 for purchasing a vehicle (e.g., vehicle 200) in exchange for operational data. For example, per the terms of a purchase agreement (e.g., identifying the type of operational data to be provided), data collection agency 160 may receive operational data (e.g., from a plurality of vehicles). Data collection agency 160 may aggregate the received operational data. Data collection agency 160 may also redact or anonymize some aspects of the received operational data, such as the identity of a driver, the make of a car, or the like. Data collection agency 160 may also compartmentalize the operational data. For example, data collection agency 160 may compartmentalize the operational data based on type (e.g., operational data relating to vehicular accidents during a specific time period, operational data for all vehicles sold from a specific dealership, operational data relating to a specific type of vehicle, operational data for vehicles insured by a particular company, etc.). Data collection agency 160 may provide offers to sell the operational data to companies 130 and/or any other interested company, individual, or party. Thus, data collection agency 160 may serve as a third-party data acquisition company structured to aggregate, compartmentalize, and sell the acquired operational data.

As shown, companies 130, data collection agency 160, vehicle dealerships 110, and processing circuit 150 may be communicably coupled via network 140. Accordingly, network 140 may include any type of communication interface that communicably couples the aforementioned components. For example, network 140 may include the internet, Wi-Fi, a cellular protocol, a wired protocol (e.g., optical cables, etc.), and the like. Network 140 may include one or more servers, where the servers are geographically separate from each other. Network 140 may include any type of component (e.g., cellular towers, servers, communication bus, wireless local area network, telephone lines, etc.) that facilitates communication between and among the components in system 100.

As shown, processing circuit 150 includes processor 151 and memory 152. Referring to the components of processing circuit 150 separately, processor 151 may be configured as one or more servers that include one or more processors. Typically, processor 151 is structured to perform all or most of the functions of processing circuit 150 as described herein. In some embodiments, the functions of processing circuit 150 described herein are performed by instructions (e.g., software) on machine-readable media including various hardware components. Processor 151 may be implemented as a general-purpose processor, an application specific integrated circuit (ASIC), one or more field programmable gate arrays (FPGAs), a digital-signal-processor (DSP), a group of processing components, or other suitable electronic processing components. Memory 152 may be configured as one or more memory devices, which are configured to store operational data, provide operational data, provide incentives (via processor 151) based on one or more conditions of a vehicle purchase transaction, and other functions described herein. Memory 152 may be or include non-transient volatile memory or non-volatile memory. Memory 152 may include database components, object code components, script components, or any other type of information structure for supporting the various activities and information structures described herein. Memory 152 may be communicably connected to processor 151 and provide computer code or instructions to processor 151 for executing the processes described herein.

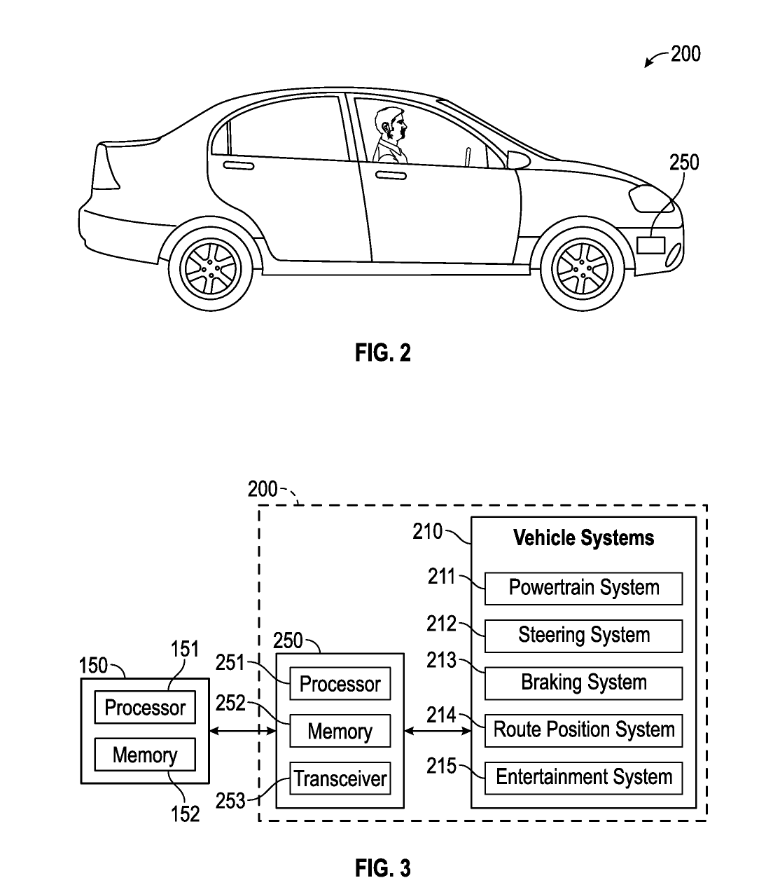

Processing circuit 150 is structured to receive an indication of a vehicle transaction. The indication refers to the start of a potential vehicle transaction. The indication may come from a salesman at dealership 110, directly from potential customer 120 (e.g., via a website of dealership 110, etc.), and any other method or process that begins a vehicle transaction. For example, a customer may click on a link on a dealership's website that starts a quoting process for a vehicle of interest. A vehicle transaction refers to any type of transaction for the purchase, lease, or acquisition of a vehicle (e.g., vehicle 200 in FIG. 2). For example, the type of transaction may include a full purchase, which indicates that the customer is not financing the purchase (e.g., paying for the vehicle in cash). In another example, the type of transaction may include a financed purchase, which indicates that the customer is taking out a loan to purchase the vehicle.

As part of the vehicle transaction, processing circuit 150 is structured to receive one or more conditions or terms regarding the vehicle transaction. These one or more conditions may include purchase data and customer data, each of which is described below. Similar to reception of the initiation of the vehicle transaction, the one or more conditions may be received from a salesman at dealership 110, directly from potential customer, and/or be standard to a particular dealership 110. As described below, the conditions (e.g., purchase data and customer data) may dictate the incentive provided by the incentive system, which includes processing circuit 150.

The purchase data may include information regarding a type of purchase for the vehicle. For example, the purchase data may include whether the vehicle transaction is a lease transaction, a full purchase, or a financed purchased. The purchase data may also include what type of vehicle is being sold (e.g., the subject of the vehicle transaction). This information may include a make and model of the vehicle. The purchase data may also include an identification of at least one of a seller of the vehicle, a lessor of the vehicle, and a vehicle dealership. The purchase data may also include information related to at least one of a previous ownership of the vehicle, an age (e.g., mileage, calendar age) of the vehicle, a condition (e.g., mechanical, electrical, appearance) of the vehicle, and a history (e.g., maintenance, accident, service) of the vehicle.

The customer data refers to information regarding a customer that may purchase the vehicle. The customer data may include whether he/she is a first time vehicle buyer (e.g., repeat customers may receive a larger incentive, etc.) or a first time customer of information-for-purchase-incentives. The customer data may include an identity, gender, or age of the customer. The customer data may include an amount of down payment monies he/she intends to put towards the vehicle purchase (e.g., relatively higher down payment monies correspond to relatively larger incentives). The customer data may include information relating to their driving record. For example, if their record indicates a tendency of accidents (e.g., five accidents in the past two years, etc.), they may receive a higher incentive to purchase the car because the insurance company may make that money back in the higher premiums for insuring accident-prone customer. The customer data may also include an indication of whether he/she has a coupon to use with the vehicle purchase (e.g., a lower incentive may be provided if the customer has a coupon, due to the customer already receiving a financial incentive for the purchase of the vehicle). The customer data may further include an indication whether he/she is trading-in another vehicle (e.g., if so, that may qualify him/her for a relatively larger incentive).

The purchase data may also include information relating to the black box itself. For example, if a black box is already included in the vehicle to be purchased, then a relatively smaller incentive may be provided compared to if the customer buys a separate black box unit that must be installed. This is due to the extra labor, time, and potential cost in installing a black box in the vehicle.

As described below, the one or more conditions may also include a characteristic of the operational data to be provided in exchange for the incentive. The characteristic may include a type of operational data (e.g., data relating to a particular vehicle system (e.g., powertrain system, etc.), data relating to environment conditions of the vehicle, etc.). The characteristic may also include a frequency of providing the operational data (e.g., continuously, after a certain event, etc.) to processing circuit 150. The effect of the characteristic of the operational data and whether the black box needs to be installed in the vehicle is described more fully herein below after explanation of FIGS. 2-3.

Based on the received conditions, processing circuit 150 provides an incentive for the vehicle transaction. According to one embodiment, the incentive is a financial incentive to help the customer purchase the vehicle. Accordingly, the financial incentive may include, but is not limited to, a rebate, a loan, a price discount, a monthly payment reduction (e.g., relative to a determined monthly payment for a particular vehicle without an applied incentive), a payment number reduction (e.g., a reduction in the number of monthly payments), an interest rate reduction, and a down payment reduction. Thus, the incentive is structured as an “upfront incentive” as opposed to a gradual incentive (e.g., a reduced insurance premium, etc.). As a result, customers may appreciate the incentive immediately, which may cause them to complete the purchase of the vehicle.

As mentioned above, one or more conditions of the vehicle transaction may affect the incentive provided by processing circuit 150. While the above conditions relate to a type and frequency of provided operational data, information relating to the specific customer (customer data), and purchase data, there are many other conditions or circumstances that also affect the incentive provided by processing circuit 150. These other conditions and circumstances may be included in the purchase data received by processing circuit 150. The other conditions may include information relating to a particular dealership in dealerships 110. For example, if a particular dealership meets a sales quota for a certain period of time, processing circuit 150 may provide a relatively greater incentive (e.g., from a ten percent discount to a fifteen percent discount in down payment monies required for new vehicle purchases, etc.) to that dealership. Accordingly, that dealership may be able to attract additional customers from the additional incentive. Another circumstance may be the particular terms of the vehicle transaction. For example, processing circuit 150 may provide a relatively greater incentive for a three-year loan commitment than for a five-year loan commitment, due to a likelihood that the monthly payments would be higher for the three-year loan payment than the five-year loan payment (i.e., the higher monthly payments may be somewhat offset due to the incentive, which may appeal to customers). In another example, the terms of a lease transaction (e.g., a duration and/or a number of miles) may impact the incentive provided by processing circuit 150 (e.g., a more expensive lease agreement may be offset with a relatively greater incentive).

Processing circuit 150 may also at least partly base the incentive on purchase data that includes the type of vehicle in the vehicle transaction. As described herein, processing circuit 150 may selectively provide the incentive based on a pooled amount of resources from at least one of association of companies 130 and data collection agency 160. In other words, at least one of companies and data collection agency 160 provides the compensation corresponding to the incentive provided by processing circuit 150. If companies 130 are configured as insurance companies, companies 130 may authorize processing circuit 150 to provide a relatively greater incentive for vehicle transactions regarding vehicles that have relatively higher insurance premiums (e.g., sports cars, etc.). As a result, customers may be attracted to those vehicles, despite the relatively higher insurance premiums.

Processing circuit 150 may also at least partly base the incentive on the time of year. For example, during peak holiday times (e.g., black Friday shopping, etc.), processing circuit 150 may provide relatively greater incentives in order to spur holiday spending.

Processing circuit 150 may also at least partly base the incentive on the cost of the vehicle (or how much the customer spends if the black box is sold separately and then needed to be installed). For example, customers that desire to purchase vehicles priced between $10,000 and $20,000 may be provided with a five percent reduction in down payment monies or a five percent monthly payment reduction, customers that desire to purchase vehicles priced between $20,001 to $30,000 may be provided with a seven percent reduction in down payment monies or a seven percent monthly payment reduction, etc.

As described above, many conditions may affect the incentive provided processing circuit 150. The particular delineations of what incentive is provided (e.g., down payment reduction, monthly payment reduction, whether a cash rebate is provided, etc.) is widely configurable based on the conditions of the vehicle transaction. While only a few example embodiments are described above, it should be understood that many other configurations are contemplated with all such configurations intended to fall within the spirit and scope of the present disclosure.

As mentioned above, processing circuit 150 is structured to provide an incentive in exchange for a customer providing operational data regarding operation of a vehicle. Accordingly, the type and frequency of receiving operational data (i.e., characteristics of operational data) may affect the incentive provided by processing circuit 150. As described below in regard to FIGS. 2-3, according to one embodiment, the type of operational data may include any type data tracked by an electronic control module (e.g., engine control module, transmission control module, powertrain control module, exhaust after treatment control module, etc.) in a vehicle. For example, the type of operational data may include, but is not limited to, an indication of at least one of a history of fault codes generated, a history of warning lamps generated, a history of engine speed, and a history of tire pressure. The type of operational data may also include information related to usage of the vehicle, such as location of the vehicle, speed of the vehicle, travel direction of the vehicle, steering of the vehicle, turn signal usage for the vehicle (e.g., for correlation with steering history), seat belt usage for the vehicle, and traffic citations for the vehicle. The type of operational data may also include accident-related data. The accident-related data may include any type of data collected at or during an accident. Accordingly, the accident-related data may include, but is not limited to, an indication of at least one of a seat belt position at or near a time of a vehicle accident, an air bag position at or near a time of a vehicle accident, a vehicle speed at or near a time of a vehicle accident, a transmission setting at or near a time of a vehicle accident, an accelerator setting at or near a time of a vehicle accident, a steering setting at or near a time of a vehicle accident, a travel direction at or near a time of a vehicle accident, a location at or near a time of a vehicle accident, a radio sound level at or near a time of a vehicle accident, and a voice recording at or near a time of a vehicle accident (e.g., if an operator was on the phone). The accident-related data may also include any video or camera images of the cabin of the vehicle at or near the time of the accident (e.g., to determine if the operator was distracted, etc.). The type of operational data may also include data relating to the surrounding environment of a vehicle. For example, the operational data may include whether a proximity sensor detected the presence of a vehicle at or near the time of an accident, a weather condition at a particular time of vehicle operation, etc.

According to one embodiment, processing circuit 150 is structured to provide a relatively greater incentive based on the customer agreeing to provide a relatively greater amount of data. For example, if the customer only agrees to provide the history of fault codes data, processing circuit 150 may only provide a one-percent reduction in monthly payments. However, if the customer agrees to provide all of the data tracked by a black box, processing circuit 150 may provide a ten-percent reduction in monthly payments.

As mentioned above, processing circuit 150 may also adjust the incentive provided based on how frequently the operational data is provided to processing circuit 150. For example, the operational data may be provided “on-demand” (e.g., whenever processing circuit 150 transmits a request for data), continuously, after a claimable event (e.g., post-accident), for a life of payments for the vehicle, for a term for which an insurance company covers the vehicle, etc. According to one embodiment, processing circuit 150 provides a relatively greater incentive for relatively more frequent receiving of operational data (e.g., customers that permit continuous providing of operational data may receive a $1000 cash rebate, while customers that permit operational data to be transmitted only after a claimable event receive a $200 cash rebate).

In some embodiments, the type and frequency of operational data provided may collectively affect the incentive provided by processing circuit 150. For example, although a customer agrees to only provide a history of fault code data, if the customer agrees to provide this data continuously, he/she will receive a $500 cash rebate compared to a $300 cash rebate if he/she agrees to provide the history of fault code data only after a claimable event. This type of configuration may be a standard arrangement for first-time buyers at a particular dealership. However, if the customer is a repeat customer, the cash rebate may be increased by $100 (e.g., a $600 cash rebate versus a $400 cash rebate).

As with other conditions regarding the purchase of a vehicle as described above, the particular incentive and quantity thereof may vary widely based on the application. Accordingly, the aforementioned description is only intended to depict a few examples, such that many more configurations are possible with all such variations intended to fall within the spirit and scope of the present disclosure.

According to one embodiment, processing circuit 150 is structured to provide a standard incentive based on the type of vehicle transaction, customer data, and the operational data agreed to be provided by the customer. For example, a customer may be interested in a 10,000 mile lease of a four door sedan with a price tag of $15,000. This may be a first time customer, who is only interested in providing history of fault code data after a claimable event (i.e., the type and frequency of operational data). Based on these conditions, processing circuit 150 directly (or, indirectly, such as via a salesman at a dealership) offers the customer either a $500 cash rebate or a five percent monthly payment reduction. In operation, a salesperson at a dealership of dealerships 110 may provide the aforementioned to a website communicably coupled to processing circuit 150, where processing circuit 150 provides the aforementioned incentive in response to inputted information.

According to one embodiment, processing circuit 150 is structured to adjust one or more conditions relating to the vehicle transaction. In regard to the above example, the customer may counteroffer saying that he/she wants either a $1000 cash rebate or a ten percent monthly payment reduction in order to agree to lease the vehicle. Based on this counteroffer, processing circuit 150 may agree to those terms, but require that all acquired operational data be provided continuously. If the customer agrees to this second offer by processing circuit 150, a deal may be formed between processing circuit 150 and the customer. In some embodiments, the deal or agreement may be subject to approval by a manager at a dealership 110. For example, the manager at the dealership may have adjusted one or more pricing policies that are not reflected yet by the operations of processing circuit 150. Accordingly, by including a fall back contingency approval (e.g., by the manager or another designated salesperson, or by a designated representative for association 130, etc.), processing circuit 150 substantially ensures that the details of the agreement are in accord with the dealership (and, in some embodiments, a company of companies 130) guidelines.

As mentioned above, processing circuit 150 may provide the incentive based on instructions provided by at least one of companies 130 and data collection agency 160. Companies 130 and/or data collection agency 160 may have predefined standards, guidelines, policies, rules, and the like that dictate the incentive to be provided by processing circuit 150. For example, the standard incentive provided by processing circuit 150 (described above) may be based on a guideline of companies 130 (e.g., first time buyers have a maximum incentive of a $1000 cash rebate regardless of the terms/conditions of the proposed transaction). Processing circuit 150 may utilize one or more formulas, algorithms, processes stored in memory 152 that are consistent with the guidelines on providing an incentive as set forth by companies 130 and/or data collection agency 160.

According to one embodiment, after an agreement has been completed, processing circuit 150 receives the operational data per the terms of the agreement (e.g., the type of operational data and a frequency of how often processing circuit 150 receives the operational data). As described herein, processing circuit 150 may store and compartmentalize the received operational data. Processing circuit 150 may then provide the operational data to at least one of companies 130 and data collection agency 160.

According to one embodiment, processing circuit 150 only provides the received operational data to a company (within companies 130) that insures the purchased vehicle. In this regard, processing circuit 150 may receive a selection of a company (within companies 130) to provide the operational data. For example, one of the conditions of the incentive may be that car insurance must be purchased from a company within association of companies 130. Assuming the customer wants the incentive and chooses a particular company within companies 130 (e.g., Company A) (with such selection received by processing circuit 150), processing circuit 150 only provides the received operational data to Company A. According to an alternate embodiment, processing circuit 150 provides the operational data to all the companies that comprise association of companies 130. In still other embodiments, processing circuit 150 may receive an authorization to provide the received operational data to any interested party based upon a purchase of the operational data.

Processing circuit 150 may be structured to provide the incentive for a predetermined duration of time. The predefined duration of time may correspond to at least one of a term of vehicle payments for the vehicle and a duration of insurance coverage for the vehicle by a particular company. For example, in certain embodiments, to reduce potential lost profits, processing circuit 150 may be preprogrammed to only provide the incentive (i.e., a recurring incentive such as a monthly payment reduction or an interest reduction) for as long as a particular company insures the vehicle. For example, Company A is an insurance company and part of association of companies 130, and the customer has selected Company A to insure their recently purchased vehicle. After three years, the customer has chosen to cancel their insurance with Company A and hire Company B. At which point, the customer would lose their incentive (e.g., the monthly payment reduction). Moreover, if Company B is not a part of companies 130 (and has no agreement in place to purchase or otherwise be provided with operational data regarding operation of the customer's vehicle), Company B and the customer may also be unable to consummate a deal for a reduced payment (unless the reduction is provided independent of the receipt of operational data). This functionality may only be applicable to recurring incentives provided by processing circuit 150. Recurring incentives refer to an incentive that is provided continuously, periodically, and/or more than one time. For example, a recurring incentive may include, but is not limited to, a monthly payment reduction, reduction in the number of required payments, and an interest rate reduction. In each case, the recurring incentive is still provided at an initial “upfront” time in the vehicle transaction.

As briefly described above, processing circuit 150 may provide certain types of operational data to only parties that pay for the data. For example, if the operational data is collected by data collection agency 160, processing circuit 150 may only provide specific types of the operational data to companies (e.g., one or more companies in companies 130) and individuals that pay for the data. For example, as described more fully below, processing circuit 150 may aggregate and compartmentalize the operational data based on a type of vehicle it relates to. If a company is only interested in operational data for that type of vehicle, the company has the option of purchasing only that type of data. Upon purchasing, processing circuit 150 provides that type of data to the purchaser.

In some embodiments, processing circuit 150 may adjust the incentive post-consummation of the deal based on receiving a request. The request may include a request to change the type and/or frequency of providing operational data by the customer. For example, if the customer was a given a five percent reduction on a monthly payment in exchange for providing all the operational data after a claimable event, the customer may have the option of increasing the percent reduction to seven percent if the customer agrees to continuously provide the operational data (rather than only after the claimable event). However, applicability of the incentive adjustment post-deal consummation may be in limited circumstances. For example, if the customer chose a cash a rebate as the incentive, processing circuit 150 may be unable to adjust this incentive after disbursement of the rebate. But, if the customer chose a recurring incentive (e.g., a monthly payment reduction, an interest rate reduction, etc.), processing circuit 150 may be structured to adjust the incentive based on a future input of the customer. For example, processing circuit 150 is structured to adjust the recurring incentive based on at least one of receiving an adjustment of a type operational data received and a frequency of reception of the type of operational data. Processing circuit 150 is structured to reduce the recurring incentive based on the adjustment indicating at least one of a relatively lower amount of types of operational data received and a relatively lower frequency of reception of the type of operational data. Comparatively, processing circuit 150 is structured to increase the recurring incentive based on the adjustment indicating at least one of a relatively greater amount of types of operational data received and a relatively greater frequency of reception of the type of operational data.

As mentioned above, in one embodiment, processing circuit 150 is structured to receive operational data from one or more black boxes 250. To aid explanation of this structure and further functionality of processing circuit 150, the function and structure of black box 250 and the interaction of black box 250 with processing circuit 150 is now explained with reference to FIGS. 2-3. FIG. 2 depicts vehicle 200 with black box 250 according to one embodiment. FIG. 3 depicts black box 250 communicably coupled to one or more vehicle systems 210 of vehicle 200 and processing circuit 150, according to one embodiment. As the incentive system described herein may be applicable to a wide variety of vehicles, vehicle 200 may include, but is not limited to, sedan automobiles, two- and three-wheeled motorbikes, sport-utility-vehicles, station wagons, vans, trucks, semi-tractor trailers, hybrid vehicles, full electric vehicles, watercraft, etc.

Black box 250 is structured to acquire data regarding operation of vehicle 200 (e.g., black box data, operational data, etc.). Accordingly, black box 250 may be structured as an event data recorder, a modified electronic control module for vehicle 200 to transmit operational data to processing circuit 150, as a part of one or more control modules in vehicle 200 (e.g., a part of powertrain control module, transmission control module, etc.), and/or any other component that may acquire and transmit operational data to processing circuit 150 or other components/devices. In the example shown, black box 250 includes processor 251, memory 252, and transceiver 253. Processor 251 may be configured as one or more servers that include one or more processors. Typically, processor 251 is configured to perform all or most of the functions of black box 250 as described herein. In some embodiments, the functions of black box 250 described herein are performed by instructions (e.g., software) on machine-readable media including various hardware components. Processor 251 may be implemented as a general-purpose processor, an application specific integrated circuit (ASIC), one or more field programmable gate arrays (FPGAs), a digital-signal-processor (DSP), a group of processing components, or other suitable electronic processing components. Memory 252 may be configured as one or more memory devices, which are configured to store operational data, compartmentalize the operational data, and selectively transmit operational data. Memory 252 may be or include non-transient volatile memory or non-volatile memory. Memory 252 may include database components, object code components, script components, or any other type of information structure for supporting the various activities and information structures described herein.

As shown, black box 250 is communicably coupled to vehicle systems 210 of vehicle 200. Communication between and among black box 250 and vehicle systems 210 may be via any number of wired or wireless protocols. For example, a wired system may include a serial cable, a fiber optic cable, a CAT5 cable, universal serial bus (USB; including all micro, mini, and standard types), twisted-pair cables, coaxial cables, and/or any other form of wired connection. In comparison, a wireless system may include the Internet, cellular, radio, Wi-Fi, a wireless local area network (WLAN), Bluetooth, radio frequency (RF), optical communication, infrared, microwave, sonic and ultrasonic waves, and electromagnetic induction communications platforms. In one embodiment, a controller area network (CAN) bus provides the exchange of signals, information, and/or data. The CAN bus may include any number of wired and wireless protocols.

As shown, vehicle systems 210 include powertrain system 211, steering system 212, braking system 213, route position system (e.g., a global positioning system, etc.) 214, and entertainment system 215. Steering system 212 refers to the components and control systems that enable directional control of the vehicle. Braking system 213 refers to the components and control systems for the brakes of vehicle 200. Powertrain system 211 refers to the propulsion components and control systems of vehicle 200. Powertrain system 211 may include an engine, a transmission, a drive/propeller shaft, a differential, and a final drive (e.g., the wheels of vehicle 100). Because vehicle 200 is widely variable (e.g., full electric to a solely internal combustion engine driven vehicle), the components of powertrain system 211 (and vehicle 100, in general) may also be widely variable. For example, the engine may include a spark-ignition engine or a compression-ignition engine. The transmission may include an automatic transmission, a manual transmission, a dual clutch transmission, etc. Route position system 214 refers to the components and systems that determine and may provide an indication of the geographic location of vehicle 200. Entertainment system 215 refers to the components and systems that comprise the entertainment features on vehicle 200 (e.g., radio, display screen, speakers, etc.). Additionally, vehicle systems 210 may include a heating and air conditioning system, an exhaust treating system, and an environment monitoring system (e.g., proximity sensors positioned around vehicle 200 that are configured to detect when objects are within a certain proximity of vehicle 200).

Black box 250 is structured to acquire operational data from one or more of vehicle systems 210. Vehicle systems 210 may include one or more sensors and/or monitoring devices (e.g., camera, video camera, etc.) that acquire data regarding operation of the vehicle system. Operational data may include data received from vehicle systems 210. The operational data may include, but is not limited to, a vehicle speed; an engine speed; a separation distance to other vehicles; a vehicle load; a current gear/setting of a transmission; a history of fault codes generated; etc. The operational data may also include metadata, such as the driver on a particular occasion, a number of passengers in the vehicle on a particular occasion, night/weather conditions (e.g., via an environment monitoring system), radio/phone distractions, voice or video recordings of the passengers and driver of the vehicle, etc. The operational data may also include accident-related data, as mentioned above (e.g., a seat belt position at or near a time of a vehicle accident, an air bag position at or near a time of a vehicle accident, a vehicle speed at or near a time of a vehicle accident, a transmission setting at or near a time of a vehicle accident, an accelerator setting at or near a time of a vehicle accident, a steering setting or orientation (e.g., the steering wheel is oriented ninety-degrees right of center, etc.) at or near a time of a vehicle accident, a travel direction at or near a time of a vehicle accident, a location at or near a time of a vehicle accident, a radio sound level at or near a time of a vehicle accident, and a voice recording at or near a time of a vehicle accident, etc.).

Based on the acquired operational data, transceiver 253 of black box 250 is structured to selectively provide the acquired operational data to processing circuit 150 (e.g., via network 140). According to one embodiment, transceiver 253 includes wireless protocol components that enable transceiver 253 to automatically transmit the operational data without operator intervention. In other embodiments, the operator may have to download the operational data (e.g., via a USB plug-in in vehicle 200, etc.) and manually transmit (e.g., upload the operational data files to a data collection website, email the operational data files to an address monitored by processing circuit 150, etc.) the operational data to processing circuit 150. All such variations are intended to fall within the spirit and scope of the present disclosure.

Processing circuit 150 is structured to aggregate and compartmentalize (e.g., categorize into electronic folders, etc.) the operational data. For example, processing circuit 150 may be communicably coupled to a plurality of black boxes, such that processing circuit 150 receives a rather voluminous amount of operational data. Processing circuit 150 may aggregate the received operational data and compartmentalize it for future use (e.g., to sell various pieces of the data).

While aggregation and compartmentalization of the operational date is described below in regard to processing circuit 150, it should be understood that black box 250 may include similar functionality. Black box 250 may compartmentalize acquired data from vehicle systems 210. Compartmentalization may be based on a type of operational data, a time or time frame of acquisition, etc. Black box 250 may then selectively transmit the compartmentalized acquired data based on an agreement for purchase of the vehicle (e.g., the agreement provides an indication of a type of operational data to acquire and the frequency that black box 250 transmits the operational data). In some embodiments, processing circuit 150 may provide the purchase data to the black box, where the purchase data provides an indication of a type of operational data to acquire and a frequency of transmission. Accordingly, processing circuit 150 synchronizes operation of black box 250 with purchase agreement for the vehicle.

As mentioned above, processing circuit 150 may compartmentalize the data based on a type. For example, all operational data relating to the generation of fault codes may be stored in one file. Processing circuit 150 may compartmentalize the data based on the type of vehicle transaction (e.g., purchase, financed purchased, lease, etc.). Processing circuit 150 may compartmentalize the data based on the incentive provided (e.g., all operational data acquired as a result of a cash rebate may be in one folder, all operational data received as a result of a monthly payment reduction may be in another folder, etc.). Processing circuit 150 may compartmentalize the data based on vehicle origination (e.g., which dealer sold the vehicle). Processing circuit 150 may compartmentalize the data based on claimable events (e.g., data acquired relating to an accident may be stored in one folder, etc.). Processing circuit 150 may compartmentalize the data based on customer data. Processing circuit 150 may compartmentalize the data based on the type of vehicle that was sold in the transaction. Processing circuit 150 may be communicably coupled to an input/output device (e.g., a computer) that allows a user to search (e.g., sort based on a characteristic, etc.) and review the acquired data. Processing circuit 150 may compartmentalize the received operational data based on a variety of different factors, with all such variations intended to fall within the spirit and scope of the present disclosure.

According to one embodiment, processing circuit 150 may sell the aggregated and/or compartmentalized operational data. For example, if processing circuit 150 is included with data collection agency 160, data collection agency 160 may offer to sell operational data to one or more interested parties. As mentioned above, in one embodiment, processing circuit 150 only provides the received operational data relating to operation of a particular vehicle to the company of companies 130 that insures the particular vehicle. According to one embodiment, the company may sell the received operational data to other interested parties. For example, processing circuit 150 may condition receipt of the incentive on the ability of the company receiving the operational data being allowed to sell the operational data to third parties.

According to one embodiment, black box 250 may be a separate saleable item relative to vehicle 200. Processing circuit 150 may provide a relatively greater incentive (e.g., an additional $200 cash rebate) to customers that purchase black box 250 and install black box 250 in their car. Accordingly, black box 250 may be sold as an add-on component to the vehicle in the vehicle transaction.

In one embodiment, processing circuit 150 is also structured to provide a command to black box 250 (e.g., via network 140). The command may include an instruction regarding how often the operational data acquired is to be transmitted to processing circuit 150. The command may include the type of operational data to be transmitted to processing circuit 150. The command may also include a stop command signifying that no additional operational data is to be transmitted to processing circuit 150 (e.g., if the customer has ended their agreement). For example, the command to stop may be based on receiving an indication of a subsequent sale of the vehicle, an indication of a change in insurance for the vehicle, an account closing payment (e.g., the last payment in a lease agreement, the last payment agreed to provide as part of the vehicle transaction for the incentive, etc.), etc.

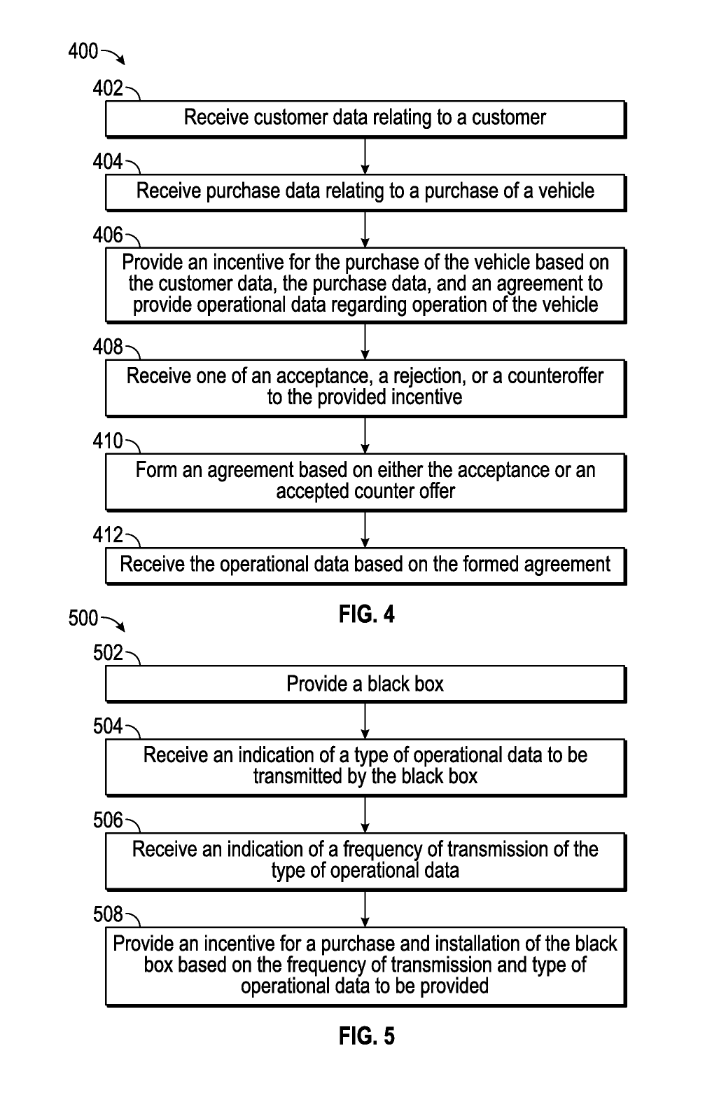

Referring now to FIGS. 4-6, methods of incentivizing customers to purchase vehicles in exchange for providing operational data are shown according to various embodiments. Various portions of methods 400-600 may be implemented with processing circuit 150 (and other components of FIGS. 1-3), such that reference may be made to the components of FIGS. 1-3 to aid explanation of methods 400-600.

Method 400 represents a method of providing an incentive to a potential customer to purchase a vehicle in exchange for providing operational data. Method 400 may begin by receiving customer data relating to a customer for a vehicle (402). The customer data may include, but is not limited to, an indication of whether he/she is a first time buyer or a repeat customer, whether he/she has a coupon, their driving record, a credit report, and the like. This customer data may be received by a processing circuit, such as processing circuit 150. Purchase data relating to a purchase of vehicle is then received (404) (e.g., by processing circuit 150). This purchase data may include a type of purchase (e.g., a financed purchase, a full purchase, a lease agreement, etc.), the type of vehicle to be purchased, and the like as described above. Based on the customer data and the purchase data, an incentive is provided conditioned on a customer agreeing to provide operational data (406). The incentive may be a financial incentive configured to induce a customer to purchase the car. Accordingly, as mentioned above, the incentive may include a cash rebate, a monthly payment reduction, an interest rate reduction, a number of payments reduction, etc. An acceptance, rejection, or a counteroffer to the provided incentive is received (408). For example, a salesperson presents the incentive in the vehicle purchase offer. A customer may accept the offer. At which point, the salesperson uploads this confirmation of acceptance to the processing circuit. Alternatively, the customer may wish to change a condition of the purchase of the vehicle. For example, with a lease agreement, the customer may request additional miles-per-year and a larger incentive. The customer may reject the vehicle purchase offer and the transaction is ended. Based on either an accepted counteroffer or an acceptance, an agreement is formed (410). After formation of the agreement, a command is provided to a black box of the vehicle to provide the operational data in accord with the conditions of the agreement. At which, point, operational data is received (410) (e.g., by processing circuit 150).

In some embodiments, method 400 may further include receiving a selection of a company (e.g., from companies 130). In one embodiment, the operational data received is only provided to the selected company. In another embodiment, the operational data is provided to one or more non-selected companies in the association of companies based on receiving an indication that a non-selected company has purchased the operational data.

An example implementation of method 400 may be described as follows. A customer enters a dealership (e.g., a particular vehicle dealership of dealerships 110). The customer shows interest in a particular type of vehicle. A salesman offers to provide the customer with a test drive. Upon driving the vehicle, the customer expresses a desire to learn more about purchasing the vehicle. Either then or before, the salesman may “intake” the customer (e.g., obtain their demographic information, whether they are a first-time buyer or not, etc.). The information relating to the customer (i.e., customer data) may be provided to the processing circuit (402). The salesman may also provide the type of vehicle and type of purchase the customer is interested in to the processing circuit (404). Based on the aforementioned information, the processing circuit may provide the salesman with an incentive to present to the customer in exchange for receiving operational data (e.g., “Congratulations! You qualify for a $1000 cash rebate contingent on you continuously providing all of your acquired operational data for a period of X months.”) (406). The customer may then tell the salesperson “I am not comfortable with providing all of that data for that duration. I will provide all operational data only after claimable events, but for full the duration of X months.” (408). The salesperson may have pre-approval for accepting this counteroffer or may have to submit the information to the processing circuit. If submitted and accepted, an agreement is formed—at least in regard to the operational data providing condition (410). Other conditions of the vehicle purchase (e.g., trade-in value, monthly payment, etc.) may be negotiable with the salesperson and unrelated to providing the operational data.

If the deal is fully consummated (i.e., the customer has leased, purchased, or otherwise acquired the vehicle), processing circuit 150 may provide one or more commands to the black box on the new vehicle. The command may activate the black box and identify what type of data to acquire and transmit, as well as the frequency of such transmission. The processing circuit may receive the operational data and provide the received data to one or more companies (e.g., the company insuring the new vehicle) (412). The one or more companies may utilize the data to track whereabouts of customers, investigate accidents, and extract other potentially beneficial metrics from the data.

Referring now to FIG. 5, method 500 of providing an incentive in exchange for purchasing and installing a black box in a vehicle is shown, according to one embodiment. Method 500 may begin by providing a black box for acquiring operational data (502). The black box provided may have a similar structure and function as black box 250. Accordingly, the black box may be structured to acquire operational data like described above. In this example, the black box is provided as a separate unit relative to a vehicle. At step 504, an indication of a type of operational data to be transmitted by the black is received (e.g., to processing circuit 150). At step 506, an indication of a frequency of transmission of the type of operational data is received (e.g., at processing circuit 150). An incentive for a purchase an installation of the black box based on the frequency of transmission and the type of black operational data received is provided (508). As in method 500, the incentive may also be based on a plurality of various other factors (e.g., customer information and/or vehicle purchase transaction information). According to one embodiment, the incentive provided is greater than an incentive provided if the black box were pre-installed in the vehicle.

An example implementation of method 500 may be as follows. A customer is at a dealership perusing black boxes that are on display for sale (502). A salesman approaches the customer and informs that customer that he/she may receive a financial incentive for the purchase and installation of the black box in a vehicle. According to one embodiment, the vehicle is newly purchased vehicle. According to another embodiment, the vehicle may be the customer's existing vehicle. If the customer shows interest in the financial incentive, the salesperson may explain the concept of operational data and who may receive the operational data (e.g., one or more insurance companies). The salesperson may ask the customer questions regarding a type of operational data that they would be comfortable providing (504) and how often they would be comfortable with providing that data (506). The salesperson may provide this information to processing circuit 150 (e.g., via a website, etc.), which then generates an incentive to purchase and install the black box based on that information (508). At this point, the customer may accept, counteroffer, or reject the offer.

Method 500 may be used to familiarize customers with the providing operational. The companies may still receive a financial benefit if the incentive is conditioned on insuring the vehicle with one of the companies in an association of companies. In other embodiments, the companies may provide the financial incentive without the aforementioned condition. In this case, customers familiarize themselves with providing operational data and may be more likely to include this feature with a future car purchase.

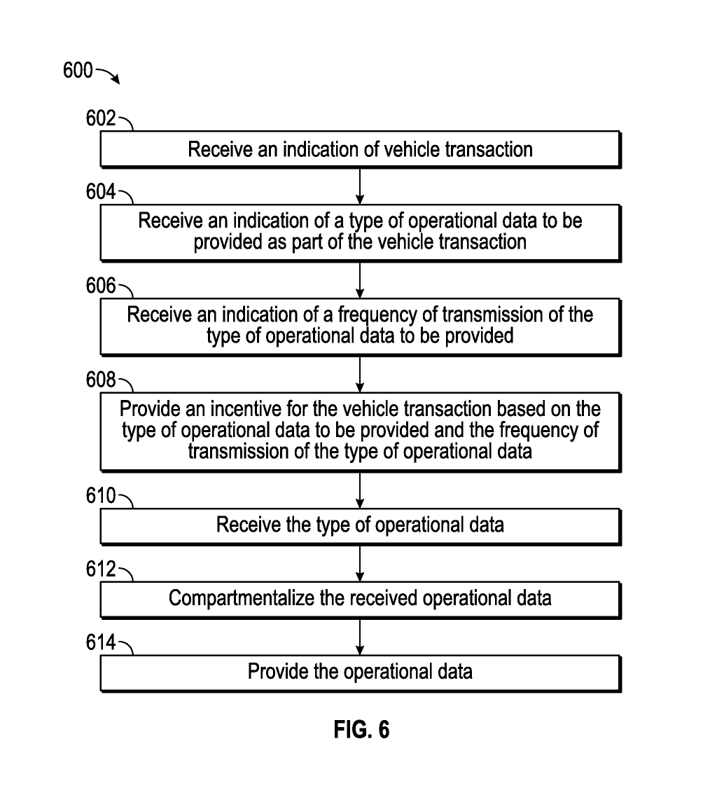

Referring now to FIG. 6, method 600 of incentivizing vehicle purchases based on operational data is shown according to one embodiment. Method 600 may be substantially similar to method 400, except that method 600 is carried through completion of an agreement (to purchase the vehicle in exchange for providing operational data) with the incentive based more dominantly on the type and frequency of providing the operational data. Accordingly, similar steps to that of method 400 are only summarized.

Method 600 may begin by reception of an indication of a vehicle transaction (602). The vehicle transaction may include a full purchase (without financing) of a vehicle, a financed purchase of a vehicle, a lease agreement for the acquisition of a vehicle, or another type of transaction. An indication of a type of operational data to be provided as part of the vehicle transaction is received (604). An indication of a frequency of how often the type of operational data to be provided is received (606). An incentive for the vehicle transaction based on the type of operational data to be provided and the frequency of transmission is provided (608). As mentioned above, the type of operational data may include, but is not limited to, data regarding operation of the vehicle, accident-related data, meta data, etc. The frequency that the operational data is provided may be continuous, on-demand, after a claimable event, periodically (e.g., once a week, every 6 months, etc.), etc. According to one embodiment, providing more types of data at more frequent transmissions corresponds with a larger incentive. Certain types of data may be more popular among purchasers of operational than other types (e.g., accident-related data). The incentive for providing the popular type(s) of data (e.g., accident-related data) may be greater than collectively providing the remainder of the data.

After formation of an agreement for the vehicle in exchange for the incentive, a command may be provided to the black box. For example, processing circuit 150 may provide a command instructing the black box to activate and transmit operational data per the terms of the agreement. According, operational data is received (610). In one embodiment, the operational data received by processing circuit 150 is a type that was agreed to. In another embodiment, all types of operational data may be transmitted and received by processing circuit 150. However, only agreed-upon type operational data may be provided (614). Other types of operational data may be stored in a secure file in memory device 152. In this case, the customer may provide an input at a later date and may be able to achieve an additional incentive based on the transmission of the accumulated data. Accordingly, there may be an option for an additional incentive at a future data, if the customer agrees to provide the accumulated and stored operational data.

With the aforementioned description, an example implementation of method 600 may be as follows. A customer is viewing a dealership website perusing vehicles. The customer selects a vehicle of interest and starts to go through an online purchasing process (or a quote process) (602). During the process, an explanation of operational data and the purpose of collecting operational data may be provided. Further, the customer may be provided with an indication that he/she may qualify for an incentive to purchase the vehicle based on agreeing to provide the operational data. The customer provides an indication of the type operational data they are willing to provide (604) and the frequency that the customer is willing to transmit the type of operational data (606). In some embodiments, the customer may also provide an input regarding a duration of how long they are willing to transmit the data (e.g., for one-year only). Processing circuit 150 receives this information and provides an incentive for the vehicle purchase (608). Assuming the customer agrees to purchase the vehicle with the incentive, the black box on the vehicle begins transmitting operational data in accord with the agreement. Processing circuit 150 receives the operational data and compartmentalizes the data (610-612). Processing circuit 150 then provides the operational data to one or more interested parties (e.g., a company that paid for the data, a company selected to insure the vehicle, etc.) (614). The transmission may continue until the duration is reached.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system for incentivizing vehicle purchases, comprising:
a processing circuit communicably coupled to a memory device for storing operational data regarding operation of a vehicle, the processing circuit structured to:
receive customer data regarding a customer for the vehicle;
receive purchase data regarding a purchase of the vehicle; and
provide an incentive for the purchase of the vehicle based on the customer data, the purchase data, and an agreement by the customer to provide the operational data.

2. The system of claim 1, wherein the processing circuit is structured to adjust the incentive based on a type of operational data received and a frequency of receiving the operational data.

3.-9. (canceled)

10. The system of claim 1, wherein the incentive is agreed to be provided over a predefined duration of time, the predefined duration of time corresponding to at least one of a term of vehicle payments for the vehicle and a duration of insurance coverage for the vehicle by a particular company.

11.-15. (canceled)

16. The system of claim 1, wherein the processing circuit is structured to receive compensation corresponding to the incentive from a company.

17. The system of claim 16, wherein the company includes an insurance-based company.

18. The system of claim 16, wherein the company includes an association of companies, wherein the association of companies includes at least one insurance-based company.

19. The system of claim 18, wherein the processing circuit is structured to receive a selection of a company from the association of companies.

20. The system of claim 19, wherein the processing circuit is structured to only provide the received operational data to the selected company.

21. The system of claim 19, wherein the processing circuit is structured to provide the received operational data to one or more non-selected companies in the association of companies based on receipt of an indication that a non-selected company has purchased the received operational data.

22. The system of claim 1, wherein the incentive includes at least one of a rebate, a price discount, a monthly payment reduction, an interest rate reduction, a payment number reduction, and a down payment reduction.

23. The system of claim 1, wherein the purchase data includes a type of vehicle purchase, wherein the type of vehicle purchase includes one of a full purchase, a financed purchased, and a lease agreement for the vehicle.

24. The system of claim 1, wherein the purchase data includes an identification of at least one of a seller of the vehicle, a lessor of the vehicle, and a vehicle dealership.

25. The system of claim 1, wherein the purchase data includes information related to at least one of a previous ownership of the vehicle, an age of the vehicle, a condition of the vehicle, and a history of the vehicle.

26. The system of claim 1, wherein the customer data includes at least one of an indication whether the customer is a first time vehicle purchaser, an indication whether the customer is a first time customer, an indication of whether the customer is a repeat customer for a particular vehicle dealership, and a driving record of the customer.

27. The system of claim 1, wherein the customer data includes at least one of an identity of the customer and an age of the customer.

28. A system, comprising:
a black box for acquiring operational data regarding operation of a vehicle; and
a processing circuit communicably coupled to a memory device for receiving the operational data from the black box, the processing circuit structured to:
receive an indication of a vehicle transaction;
receive, as part of the vehicle transaction, an indication of a type of operational data to be provided to the memory device;
receive, as part of the vehicle transaction, an indication of a frequency of transmission of the operational data to the memory device; and
provide an incentive for purchase of the vehicle in the vehicle transaction based on the type of the operational data provided and the frequency of transmission of the operational data.

29. The system of claim 28, wherein the type of operational data includes at least one of a history of fault codes generated, a history of warning lamps generated, a history of engine speed, and a history of tire pressure.

30. The system of claim 28, wherein the type of operational data includes at least one of a location of the vehicle, a speed of the vehicle, a travel direction of the vehicle, a turn signal usage for the vehicle, a seat belt usage for the vehicle, a steering orientation for a steering wheel of the vehicle, and a presence of a traffic citation for the vehicle.

31. The system of claim 28, wherein the type of operational data includes accident-related data, wherein the accident-related data includes at least one of seat belt position at or near a time of a vehicle accident, an air bag position at or near a time of a vehicle accident, a vehicle speed at or near a time of a vehicle accident, a transmission setting at or near a time of a vehicle accident, a radio sound level at or near a time of a vehicle accident, an accelerator setting at or near a time of a vehicle accident, a steering setting at or near a time of a vehicle accident, a travel direction at or near a time of a vehicle accident, a location of the vehicle at or near a time of a vehicle accident, and a voice recording at or near a time of a vehicle accident.

32. The system of claim 28, wherein the type of operational data further includes metadata regarding operation of the vehicle, wherein the metadata includes at least one of a driver identity on a particular vehicle operation occasion, a number of passengers on a particular vehicle operation occasion, an environmental condition on a particular vehicle operation occasion, and voice recording information on a particular vehicle operation occasion.

33. The system of claim 28, wherein the frequency of transmission includes at least one of continuously, on-demand, and after a claimable event.

34. The system of claim 28, wherein the processing circuit is structured to provide a relatively greater incentive based on relatively more types of operational data being provided to the memory device.

35. The system of claim 28, wherein the processing circuit is structured to provide a relatively greater incentive for providing the operational data at relatively higher frequencies.

36. The system of claim 28, wherein the vehicle transaction includes one of a full purchase of the vehicle, a financed purchased of the vehicle, and a lease agreement for the vehicle.

37. The system of claim 28, wherein the processing circuit is structured to receive operational data upon completion of the vehicle transaction.

38. The system of claim 37, wherein the processing circuit is structured to compartmentalize the received operational data, wherein the compartmentalization is based on at least one of a type of the operational data, the type of vehicle transaction, a type of incentive provided, customer data regarding a customer in vehicle transaction, and a type of the vehicle.

39.-51. (canceled)

52. A system for incentivizing vehicle purchases, comprising:
a processing circuit structured to:
receive, as part of a vehicle transaction, an indication of a type of operational data to be received;
receive, as part of the vehicle transaction, an indication of a frequency of transmission of the operational data to be received;
receive, as part of the vehicle of transaction, customer data regarding a customer of the vehicle; and
provide an incentive for a purchase of the vehicle in the vehicle transaction based on the type of operational data provided, the frequency of transmission of the type of operational data, and the customer data.

53. The system of claim 52, wherein the incentive includes at least one of a rebate, a price discount, a monthly payment reduction, a payment number reduction, an interest rate reduction, and a down payment reduction.

54.-56. (canceled)

57. The system of claim 52, wherein, upon completion of the vehicle transaction, the processing circuit is structured to receive the type of operational data and compartmentalize the received type of operational data based on at least one of the type of operational data, the customer of the vehicle, the incentive provided, a type of vehicle transaction, the customer data, and the vehicle type.

58. The system of claim 57, wherein the processing circuit is structured to selectively provide the compartmentalized operational data based on at least one of an agreement to provide the operational data, receiving a request by a company insuring the vehicle, and receiving a purchase order for a type of compartmentalized data.

59. The system of claim 52, wherein the processing circuit is structured to provide a command to stop reception of the type of operational data based on receiving an indication of a subsequent sale of the vehicle, an indication of a change in insurance for the vehicle, an account-closing payment, and a duration for transmitting the operational data expiring.

60. The system of claim 52, wherein the incentive includes a recurring incentive, wherein the processing circuit is structured to adjust the recurring incentive based on at least one of receiving an adjustment of a type operational data received and a frequency of reception of the type of operational data.

61. The system of claim 60, wherein the processing circuit is structured to reduce the recurring incentive based on the adjustment indicating at least one of a relatively lower amount of types of operational data received and a relatively lower frequency of reception of the type of operational data.

62. The system of claim 60, wherein the processing circuit is structured to increase the recurring incentive based on the adjustment indicating at least one of a relatively greater amount of types of operational data received and a relatively greater frequency of reception of the type of operational data.

63. The system of claim 60, wherein the recurring incentive includes at least one of a monthly payment reduction, a payment number reduction, and an interest rate reduction.

64.-141. (canceled)
